(19) United States
(12) Patent Application Publication
(10) Pub. No.: US 2017/0010385 A1
(43) Pub. Date: Jan. 12, 2017

(54) FIBER OPTIC ARRAY HAVING DENSELY SPACED, WEAK REFLECTORS

(71) Applicant: Schlumberger Technology Corporation, Sugar Land, TX (US)

(72) Inventors: Florian Englich, Southampton (GB); Arthur Hartog, Southampton (GB)

(21) Appl. No.: 15/205,164

(22) Filed: Jul. 8, 2016

Related U.S. Application Data
(60) Provisional application No. 62/190,036, filed on Jul. 8, 2015.

(51) Int. Cl. G01V 8/16; G01M 11/00

(52) U.S. Cl. CPC G01V 8/16; G01M 11/3172

(57) ABSTRACT

A fiber optic sensing system includes a fiber optic sensor having a plurality of densely spaced, non-naturally occurring discrete reflectors having a weak reflectivity of less than 1% and, in some cases, even less than 0.0001% depending on the density of the reflectors. The fiber optic sensor is configured so that the spatial resolution of the backscattered signal generated in response to a probe signal is greater than the separation between at least two discrete reflectors, so that backscatter generated by the at least two reflectors overlaps at the receiver. Data representative of a parameter of interest, such as temperature or strain, can be acquired from the detected backscatter and processed in order to provide information about conditions in a region of interest.

This application claims the benefit of U.S. Provisional Application Ser. No. 62/190,036, entitled “Sparse Fiber Gratings,” filed on Jul. 8, 2015, which is incorporated by reference in its entirety.

### BACKGROUND

Distributed optical fiber sensors are finding considerable applications for monitoring many types of assets, such as energy cables, pipelines and hydrocarbon wells. Measurands obtained from such sensors include strain and temperature and, from these two measurands, other quantities such as flow, pressure, and even chemical composition, can be inferred in the right conditions.

Unlike multiplexed sensor arrangements that collect information from a plurality a discrete sensors on a single optical fiber, distributed optical fiber sensors provide a continuous measurement along the length of the fiber, their ability to discriminate between closely spaced features along the fiber being determined by their spatial resolution. In general, distributed fiber optic sensors work on the principle of backscattering, i.e., the fact that a probe signal launched into the fiber returns a signal that results from interaction of the probe signal with some inhomogeneity in the glass forming the fiber. Several different types of backscattered light can be detected and used to acquire the measurand of interest. For example, in the case of distributed sensors to measure temperature, the most common type of backscattering that is used is spontaneous Raman scattering that results from thermally-populated molecular vibrations. For strain and temperature distributed sensing, spontaneous Brillouin scattering often is used. The use of spontaneous Brillouin scattering relies on the interaction by the probe signal and acoustic phonons—vibrations that have an acoustic wavelength close to the optical wavelength of the probe. Distributed sensors based on stimulated Brillouin scattering are also known. Finally, Rayleigh backscatter, caused by frozen-in inhomogeneities in the refractive index, also can be used for some types of distributed strain and temperature sensors, but is more commonly employed for dynamic strain measurement.

### SUMMARY

A fiber optic sensing system to monitor a parameter of interest includes an optical fiber sensor having a plurality of non-naturally occurring discrete reflectors disposed along a length of an optical fiber at spaced-apart locations. Each of the discrete reflectors has a reflectivity of less than 1% at a first wavelength. The system further includes an interrogation system to launch probe signals at the first wavelength into the optical fiber sensor to monitor the parameter of interest, and a receiver to receive backscattered light reflected from the discrete reflectors in response to the probe signals. The spacing between adjacent reflectors is less than the spatial resolution of the interrogation system so that the backscattered light reflected from at least two discrete reflectors overlaps at the receiver.

A method to monitor a parameter in a region of interest also is disclosed. An optical fiber sensor is deployed in the region of interest. The optical fiber sensor has a plurality of non-naturally occurring, spaced-apart reflectors, each of which has a reflectivity at a first wavelength that is less than 1%. Probe signals are launched into the optical fiber sensor to monitor the parameter in the region of interest. Backscattered light generated by the reflectors at the first wavelength in response to illumination by the probe signals is received, and the parameter is determined based on the received backscattered light. The spacing between at least two reflectors is such that the received backscattered light is a combination of the backscattered light generated by the at least two reflectors when simultaneously illuminated by one of the probe signals.

A method to monitor a parameter in a region of interest also is disclosed. An optical fiber sensor permanently installed and previously deployed in the region of interest. The optical fiber sensor has a plurality of non-naturally occurring, spaced-apart reflectors, each of which has a reflectivity at a first wavelength that is less than 1%. Probe signals are launched into the optical fiber sensor to monitor the parameter in the region of interest. Backscattered light generated by the reflectors at the first wavelength in response to illumination by the probe signals is received, and the parameter is determined based on the received backscattered light. The spacing between at least two reflectors is such that the received backscattered light is a combination of the backscattered light generated by the at least two reflectors when simultaneously illuminated by one of the probe signals.

A method to monitor a parameter in a region of interest also is disclosed. An optical fiber sensor is deployed in the region of interest through a wireline cable, a slickline cable or any other type of cable used of well interventions. The optical fiber sensor has a plurality of non-naturally occurring, spaced-apart reflectors, each of which has a reflectivity at a first wavelength that is less than 1%. Probe signals are launched into the optical fiber sensor to monitor the parameter in the region of interest. Backscattered light generated by the reflectors at the first wavelength in response to illumination by the probe signals is received, and the parameter is determined based on the received backscattered light. The spacing between at least two reflectors is such that the received backscattered light is a combination of the backscattered light generated by the at least two reflectors when simultaneously illuminated by one of the probe signals.

A fiber optic monitoring system for measuring a parameter associated with a subterranean formation also is disclosed. The monitoring system includes an optical fiber deployed in a wellbore that penetrates a subterranean formation. The optical fiber has a plurality of non-naturally occurring reflectors disposed at spaced-apart locations along a first section of the fiber. The system also includes an optical source to launch probe signals having components at a first wavelength into the optical fiber. The reflectors in the optical fiber have a reflectivity at the first wavelength of less than 1%. The system further includes a receiver to detect returned scattered light reflected by the reflectors in response to the launched probe signals, and the scattered light returned from at least two adjacent reflectors overlaps at the receiver. An acquisition and processing system also is provided to determine at least one parameter of interest experienced by the optical fiber along the first section based on the detected returned scattered light.

### BRIEF DESCRIPTION OF THE DRAWINGS

Certain embodiments of the invention are described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current invention.

FIG. 1 is a schematic illustration of a distributed fiber optic sensing system, known as a coherent intensity-measuring optical time domain reflectometry (OTDR) system, according to an embodiment.

FIG. 2 is a schematic illustration of a distributed fiber optic sensing system, known as a coherent differential-phase measuring OTDR system, according to an embodiment.

FIG. 3 is a schematic illustration of a distributed fiber optic sensing system, known as a heterodyne distributed vibration sensing (hDVS) system, according to an embodiment.

FIG. 4 is a schematic illustration of a distributed fiber optic sensing system, known as an interferometric phase-recovery distributed vibration sensing (DVS) system, according to an embodiment.

FIG. 5 is a schematic illustration of a distributed fiber optic sensing system, known as a multi-frequency hDVS system, according to an embodiment.

FIG. 6 is a schematic illustration of a fiber sensing array having densely spaced weak reflectors, showing a probe pulse traveling from left to right and reflected light from the reflectors within the probe pulse, according to an embodiment.

FIG. 7 shows heterodyne backscatter signals acquired from a fiber array, such as the array of FIG. 6, according to an embodiment.

FIG. 8 shows heterodyne backscatter signals acquired from an unmodified distributed fiber optic sensor, according to an embodiment.

FIG. 9 is a schematic illustration of an arrangement that uses switched-wavelength interrogation to acquire signals from a densely spaced weak reflector fiber sensing array having regions that reflect at different wavelengths, according to an embodiment.

FIG. 10 is a schematic illustration of an arrangement that uses wavelength-multiplexed interrogation to acquire signals from a densely spaced weak reflector fiber sensing array having regions that reflect at different wavelengths, according to an embodiment.

FIG. 11 is a schematic illustration of an arrangement to acquire signals from a polarization-maintaining fiber, according to an embodiment.

FIG. 12 is a schematic illustration of an arrangement to acquire signals from a multimode fiber, according to an embodiment.

FIG. 13 is a schematic illustration of an application of a densely spaced weak reflector fiber sensing array that is deployed in a hydrocarbon well, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

Fiber optic sensors can be used to monitor a variety of different types of assets, including hydrocarbon wells, energy cables, and pipelines. In general, measurements are made using fiber optic sensors by detecting returned light that is scattered by naturally-occurring reflective features in the fiber in response to a probe signal, and can be based on spontaneous Raman scattering, stimulated Brillouin scattering, or Rayleigh scattering.

However, regardless of the type of scattering/measurement mechanism that is employed, the light that is scattered contributes to the fiber attenuation. A small fraction of this lost light is re-captured and guided by the fiber in the reverse direction and, eventually, it reaches the launching end of the fiber where it is detected and analyzed. The time from the launching of the probe signal to the detection of the backscatter at the launch end determines the position at which the measurand is sensed. Thus, by measuring the backscatter return as a function of time from launch of the probe, the spatial distribution of the measurand can be assessed.

Other variants of distributed fiber optic sensing systems also exist, such as systems that use spread-spectrum interrogation and acquisition techniques that operate in the frequency domain or use coded sequences of pulses. Examples of such systems and others include, but are not limited to, those systems that are disclosed in Am, A. B., et al., OFDR with double interrogation for dynamic quasi-distributed sensing, in OPTICS EXPRESS 22: 3: 2299-2308 (2014); Zou, W., et al., Optical pulse compression reflectometry: proposal and proof-of-concept experiment, in OPTICS EXPRESS 23: 1: 512-522 (2015); Leviatan, E., et al., High resolution DAS via sinusoidal frequency scan OFDR (SFS-OFDR), in OPTICS EXPRESS 23: 26: 33318-33334 (2015); Zhou, D. P., et al., Distributed vibration sensing with time resolved optical frequency-domain reflectometry, in OPTICS EXPRESS 20:12: 13138-13145 (2012); and U.S. Pat. No. 7,268,863. But in each of these variants, the spatial distribution of the measurand of interest is still obtained on the basis of relating propagation time to location in the fiber. For example, in the case of a frequency-domain interrogation system, the propagation time can be obtained by using a Fourier transform.

Regardless of the interrogation technique employed, the signals that are obtained in distributed sensors generally are very weak for a number of reasons. First, the amount of optical energy that is scattered at each unit location is low. For example, for a typical single-mode fiber operating at 1550 nm, the energy fraction that is scattered from the probe signal is on the order of 46×10⁻⁶ per meter. Second, the fraction of that scattered light that falls within the wavelength bands of interest is low in the case of systems using spontaneous Raman or Brillouin scattering. Third, the fraction of the scattered light that is re-captured by the waveguide and reaches the launch end of the fiber is also small. Again, for example, in the case of a typical single-mode fiber, the fraction of re-captured scattered light is on the order of 0.25% of the total scattered light. When these inefficiencies are combined, the light that is scattered, re-captured and falls in the desired frequency region can vary from 7 to 10 orders of magnitude below the probe energy per meter of fiber. As a result, the signal levels of the light available at the receiver are very low, especially after taking into account the inevitable additional transmission losses to and from the point of interest, resulting in a poor signal-to-noise ratio and therefore a poor resolution of the measurand unless other measures, such as a considerable amount of signal averaging, are employed.

Accordingly, embodiments of the techniques and systems described herein are directed to improving the efficiency of using a distributed fiber optic sensor to monitor measurands of interest, such as strain and temperature. Although the optical energy of the signal obtained from the fiber could be increased simply by increasing the energy of the probe signal that is launched into the fiber, distributed sensor systems generally already are operating close to the limits (set by the onset of non-linear optical effects) on the optical power that can be launched. Consequently, there is limited scope for improving the system performance simply by launching more probe power.

Another option that could increase the strength of the received signal would be to increase the scattering loss in the fiber. However, this option is counterproductive because increasing the scattering loss also increases the optical losses, which, in turn, compromises the maximum addressable fiber length. For the same reason, it would be counterproductive to attempt to improve performance simply by shifting the probe wavelength to a shorter one where the scattering is higher. In fact, depending on the intended range that the sensor should cover, there is generally an optimum operating wavelength that maximizes the signal at the most remote point of interest.

The scattering loss can also be controlled by selecting the dopant used in the fiber and its concentration. For example, increasing the GeO2 content of a germano-silicate glass fiber will increase the fiber's scattering and the fraction of the scattered light that is re-captured by the fiber. However, in addition to increasing the loss of the fiber, the increased capture fraction also results (at least for single-mode fibers) in a proportional reduction of the maximum allowable launch power. Thus, this option for controlling the loss also has drawbacks.

The type of scattering used for the measurement that is employed also affects the efficiency of the process. For example, stimulated Brillouin scattering, which can be used to measure temperature and strain, is a measurement technique that involves the interaction of two counter-propagating beams, offset in frequency by one Brillouin shift. Where that offset is precisely equal to the local value of the Brillouin shift, power is transferred from the beam at the higher of the two frequencies to the beam at the lower frequency. This technique is efficient, in that the additional energy scattered by the stimulated Brillouin process is captured essentially in its entirety by the fiber. In general, the sensitivity of the Brillouin frequency to temperature is about 1 MHz/K, which is relatively low compared to the sensitivity available using other measurement techniques, such as Rayleigh scattering.

Rayleigh scattering, which can be used to measure temperature and strain, employs highly coherent sources in conjunction with distributed sensors. The sensitivity of Rayleigh backscatter sensors to temperature is on the order of 1300 MHz/K, i.e., three orders of magnitude higher than Brillouin sensors. The contrast in sensitivity is due to the fact that, in the Rayleigh case, the sensor response is to a change in optical path length, whereas in Brillouin the sensitivity relies on changes to the acoustic velocity. However, the capture efficiency of a Rayleigh backscatter temperature is, as with other spontaneous backscatter systems, approximately 0.25%.

This dilemma was recently explored by L. Thevenaz, Next generation of optical fibre sensors: new concepts and perspectives, in 23RD INTERNATIONAL CONFERENCE ON OPTICAL FIBRE SENSORS, 2014, Santander, Spain: SPIE. Thevenaz proposes using a very faint, continuous fiber Bragg grating as the sensor element. When this approach is used, all the light coupled out for the sensor is reflected into the fiber and yet the sensitivity is similar to that of a coherent Rayleigh backscatter system. However, with Thevenaz's approach, it is essentially impossible to maintain, let alone make, a long (e.g., longer than 1 kilometer) fiber grating with the exquisite control on the phase of each period of the refractive index modulation that would be required.

Accordingly, embodiments of the present disclosure take a different approach to improving the efficiency of the measurement obtained with a distributed fiber optic sensor. The embodiments described herein are directed toward replacing or modifying a conventional sensing fiber with a fiber that includes a large number of non-naturally occurring discrete reflectors, each reflector having weak (i.e., less than 1%) reflectivity at a desired wavelength. Depending upon the application in which the sensing fiber is employed, the reflectors can have a reflectivity below 0.1% and, in some cases, even less than 0.0001% depending on the density of the reflectors. Such reflectors can be fiber Bragg gratings. Bragg gratings of this weak reflectivity are generally, but not necessarily, quite short, i.e, a length on the order of 1 millimeter. In one implementation of an embodiment, the discrete reflectors reflect at the same wavelength that matches the wavelength of the interrogation system, and the reflectors can be interrogated in the same manner as distributed vibration sensors, such as by using any of the interrogation techniques described in Hartog, A. et al., The optics of distributed vibration sensing, in EAGE—SECOND EAGE WORKSHOP ON PERMANENT RESERVOIR MONITORING, 2013, Stavanger: EAGE, the disclosure of which is hereby incorporated by reference in its entirety, or any other techniques described or referred to herein. As described further below, a sensing fiber that has been modified to include a large number of weak reflectors will behave like a conventional Rayleigh scattering fiber. However, the modified fiber will have far higher backscatter than the conventional sensing fiber, without a concomitant loss increase. Throughout this disclosure, the term “pseudo-scattering” will be used to describe the scattering exhibited by this type of modified fiber and the process of its response to a probe signal.

The reason for the increase in signal strength for the embodiments disclosed herein is that each discrete reflector in the fiber behaves like a discrete scatterer, but because most of the power that a reflector removes from the probe signal is re-directed to the launching end of the fiber, the process of measuring temperature and strain can be very efficient. For example, assume a conventional fiber has a Rayleigh scattering loss of 0.15 dB/km at 1550 nm. In this example, doubling the return signal would double the scattering loss, such as by increasing the dopant level or shifting the interrogation pulse to a shorter wavelength (e.g., moving the wavelength from 1550 nm to 1300 nm would approximately double the scattering loss). By contrast, with the proposed arrangement that employs a fiber with numerous weak Bragg gratings, the strength of the signal at the receiver can be doubled with an introduction of only 0.0005 dB/km of additional loss (assuming the gratings introduce no excess loss themselves).

To put it another way, to multiply the backscatter return by a factor of 10, the loss in a conventional fiber would increase to approximately 1.6 dB/km, whereas, using the embodiments described herein, the increase in loss would be only about 0.005 dB/km, a substantial increase in efficiency.

It should be understood that the techniques and arrangements disclosed herein are quite different from conventional interferometric sensor arrays, including arrays where the spacing between Bragg gratings is such that their reflections do not overlap in time. By contrast, embodiments of the modified fiber described herein have densely spaced discrete reflectors, where an average distance between reflectors is less than the spatial pulse width of the probe pulse so that the reflections from at least two discrete reflectors overlap at the receiver. The spatial pulse width, dₚ, of a pulse relates to its duration, τₚ, and the group velocity, V_{g}, of the pulse in the fiber by dₚ=τₚ*V_{g}/2.

Further, in addition to increased efficiency, the techniques and arrangements disclosed herein can also enhance the measurement technique as compared to a conventional distributed sensor in other ways in view of the fact that the phase and amplitude of the reflection from each reflector is no longer a random function of frequency and local strain. As an example, the strength of each reflector can be varied to adapt the strength of the reflected signal that is returned to the launch end as a function of distance along the fiber to correct for losses. Yet further, the fiber can be tailored so that regions of the fiber are defined that exhibit the enhanced, pseudo-scattering at separate wavelengths. As an example, the sensing fiber can be designed so that a first section of fiber provides the enhanced pseudo-scattering response at a wavelength of, say, 1550.92 nm (i.e., 193.3 THz, Channel 33 of the ITU frequency grid defined for dense wavelength-division multiplexed—DWDM—optical transmission systems) and a second section of fiber provides the enhanced response at 1551.72 nm (i.e., 193.2 THz, Channel 32 of a DWDM system), and so on. Defining sections of the fiber to respond to different wavelengths allows these sections to be interrogated independently and at a faster interrogation rate than would be limited by the length of the entire sensing fiber.

Accordingly, embodiments described herein include an optical fiber used for sensing that includes a plurality of separate, weak reflectors. The reflectors are densely spaced. That is, the separation between reflectors is smaller than the spatial resolution of the interrogation system so that the signals from multiple reflectors overlap in the optical signal that is returned and detected at the receiver. The interrogation system can then sum the electric fields of the signals from more than one reflector. The reflectors can be made by inscribing fiber Bragg gratings at intervals in the fiber, thus forming narrow band reflectors that also re-launch the reflected light mainly into the fiber in the return direction. In some embodiments, the density of the reflectors can be varied along the fiber. Yet further, the reflecting wavelength of the gratings can be varied in the fiber, so as to allow separate sections of the fiber to be interrogated independently of other sections and to avoid cumulative excess loss to and from the section of interest.

It should be noted that, throughout this description, the term “frequency” is used where the signals can be generated with electronically controlled modulators and separated in the electrical domain (for example with electronic or digital filters). In contrast, the term “wavelength” in the same context is used to denote that the separation of wavelength-encoded signals is performed with optical filters. Although the boundary is not fixed, below 10-20 GHz the term “frequency multiplexing” is used and beyond 20 GHz, the term “wavelength multiplexing” is used.

### Distributed Vibration/Acoustic Sensing

Distributed vibration/acoustic sensing (DVS) is a technique that allows the distribution of dynamic strain to be measured along the entire length of an optical fiber. The best performing approaches to the measurement are based on Rayleigh backscatter using coherent illumination. Rayleigh scattering arises from inhomogeneities in the glass that are formed by random thermal agitation when the fiber is drawn at high temperature and the material is still fluid to some extent. Density and compositional fluctuations of the material on a dimensional scale much smaller than a wavelength of the incident light result in a fraction of that light being scattered, i.e., re-directed in all directions (largely, but not perfectly, uniformly into 4π steradians). A small fraction (approximately 0.25%) of that light is re-captured by the waveguide in the return direction.

The backscattered light is detected when it returns to the launching end of the fiber. The analysis of the backscattered light can involve its amplitude, or equivalently its intensity—the intensity being proportional to the square of the amplitude—or its phase. In the simplest case, the probe is pulses of monochromatic light and so the scatterers in the fiber that are within the pulse are illuminated with light that is consistent in its phase between scatterers. However, when the electric fields of these scatterers are combined, a random, but stable, signal is received. This signal is highly sensitive to minute changes in the spacing between scatterers (for example caused by strain) or equivalently to the frequency of the light source from which the probe pulses are derived (“equivalently” because a change in frequency scales the distance between scatterers when measured in phase, i.e., in fractions of the wavelength of the optical carrier, so changing the frequency of the laser is equivalent to changing the optical distance between reflectors, e.g. by stretching the fiber). Using the intensity of the backscattered light is one way to detect the distributed vibration, by studying, for each location along the fiber (defined by the roundtrip transit time), changes from probe signal to probe signal of the intensity of the backscatter returning from that location.

FIG. 1 schematically shows an example of such an intensity measuring optical time domain reflectometry (OTDR) system 100. System 100 includes a narrowband laser 102 that generates an output that is modulated by a modulator 104 into probe pulses. The pulses then can be optically amplified in an Erbium doped fibre amplifier (EDFA) 106 prior to being launched into the sensing fiber 110 through a circulator 108. The returning Rayleigh backscatter is detected by a receiver 112 prior to being digitized and processed by an acquisition and processing system 114.

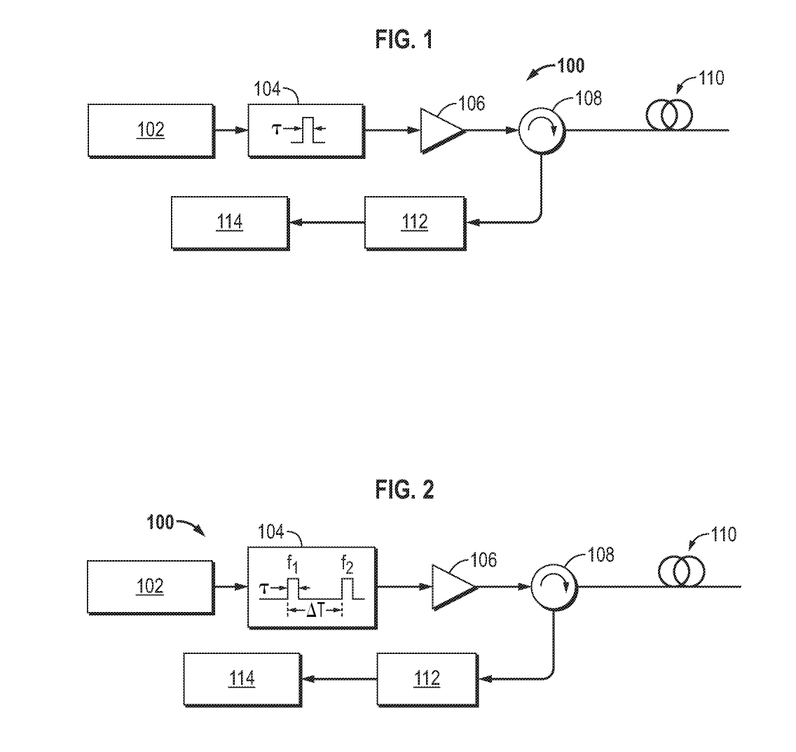

More linear approaches than the approach implemented by the OTDR system 100 of FIG. 1 have been demonstrated using the phase of the backscattered light, by comparing the phase over a defined fiber interval known as the “differentiation interval” or the “gauge length” (“GL”). As mentioned above, there are several techniques for interrogating DVS sensors using the phase. For example, FIG. 2 illustrates an interrogation scheme in which the narrowband source 102 and modulator 104 operate to generate a pair of probe pulses that are launched with a slight frequency difference f₁−f₂ and a time delay AT that defines the gauge length. The Rayleigh backscatter returns arising from each pulse overlap at the receiver 112 and the frequency difference (f₁−f₂) results in a beat frequency appearing in the receiver 112 output. The contributors to this beat signal originate from locations in the fiber 110 separated by GL=ΔT*V_{g}/2, where V_{g} is the group velocity in the fiber 110. The phase of the beat frequency is also the difference in the phase of the two optical backscatter signals that are compared in this process and a minor change in the fiber length between the locations of the scattering process for any one location is translated into a change in the phase. For a probe wavelength of 1550 nm, a change in length of 1 nm would result in a phase change of approximately 8.5 mrad.

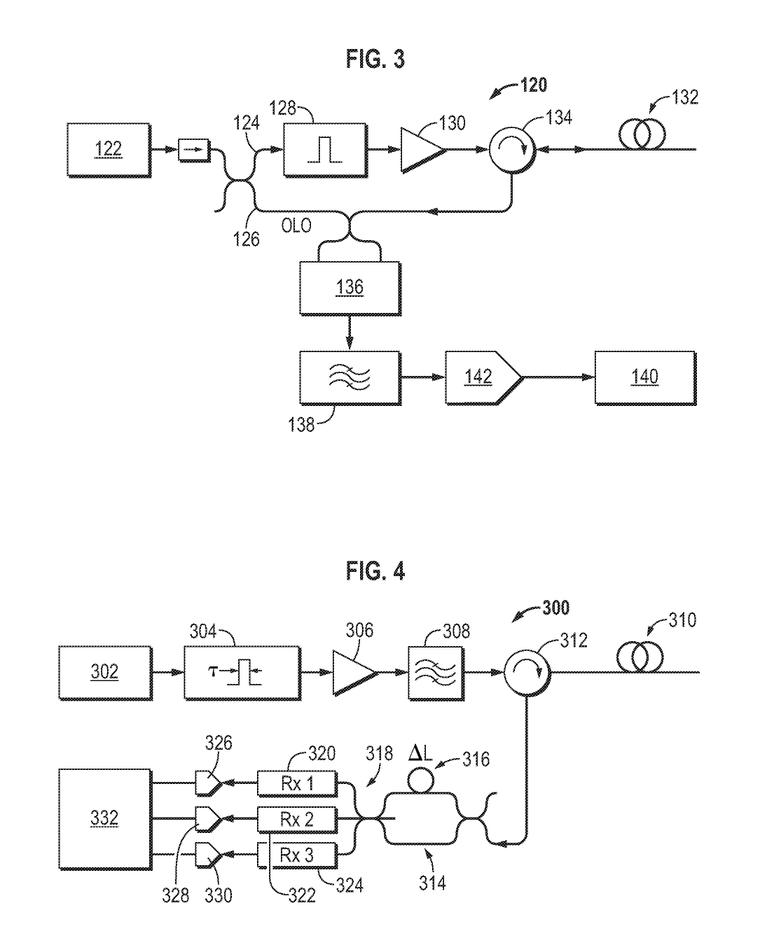

Another approach to achieving a similar result is illustrated schematically in FIG. 3 and is described in U.S. Pat. No. 9,170,149 B2. In the hDVS (heterodyne DVS) system 120 of FIG. 3, a continuous wave narrowband optical source 122 generates an output that is split between a probe signal path 124 and a local oscillator path 126. In the probe signal path 124, the signal is modulated and frequency shifted by an acousto-optical modulator (AOM) 128 prior to being amplified by EFDA 130 and launched into sensing fiber 132 through a circulator 134. At a balanced receiver 136, the backscatter signal from the fiber 132 is mixed with an optical local oscillator signal on the path 126 at a frequency that is offset from that of the probe pulse. The mixing results in an intermediate frequency (IF) at that offset frequency that preserves the phase of the backscatter signal. The output of receiver 136 is then filtered by an electrical bandpass filter 138 that passes the IF. The phase differentiation is carried out by a processing system 140 after digitization of the beat signal by the acquisition system 142. Although different optically, this approach still provides an estimate of the phase difference between backscatter signals separated by a gauge length.

Other arrangements and techniques for measuring the phase difference across a gauge length also are known, including other arrangements and techniques that are described in U.S. Patent Publication No. 2012/0067118A1, Hartog, A., et al., The optics of distributed vibration sensing, in EAGE—SECOND EAGE WORKSHOP ON PERMANENT RESERVOIR MONITORING, 2013, Stavanger: EAGE; Posey, R. J., et al., Strain sensing based on coherent Rayleigh scattering in an optical fibre, ELECTRON. LETT. 36: 20: 1688-1689 (2000); and Alekseev, A. E., et al., A phase-sensitive optical time-domain reflectometer with dual-pulse phase modulated probe signal, LASER PHYS. 24: 11: 115106 (2014). An example of one of these arrangements is illustrated schematically in FIG. 4.

In the arrangement 300 of FIG. 4, a single probe pulse is extracted from a narrowband optical source 302 (e.g., a distributed feedback laser) by an electro-optic modulator 304. The pulse is amplified by EDFA 306 and filtered by a bandpass optical filter 308 to limit amplified spontaneous emission from the EDFA 306. The amplified and filtered output signal is launched into a sensing fiber 310 through a circulator 312. Backscattered light generated by the sensing fiber 310 in response to the probe pulse is split into two arms of an interferometer 314 (e.g., a Mach-Zehnder interferometer, a fiber Michelson interferometer equipped with Faraday mirrors, and the like). The interferometer 314 compares the phase of the two copies of the backscatter signal after they have travelled through paths differing in optical length. In the embodiment shown, the difference in optical length, ΔL, is introduced by a delay line 316. In this manner, the phases of backscatter signals returning from two sections of the sensing fiber 310 separated by gauge length GL=ΔL/2 can be measured. In FIG. 4, the phases are measured using a 3×3 coupler 318 that provides outputs separated by 120° that are received by receivers 320, 322, 324. The phase information is acquired by acquisition systems 326, 328, 330 and compared by processing system 332 to compute the phases of the backscatter signals. In a variant of the arrangement of FIG. 4, the phases of the backscatter signals can be extracted using a phase-generated carrier (PGC) approach in place of the 3 x 3 coupler 318. In such an embodiment, the gauge length GL is still defined by the path imbalance of the interferometer 314, but the information is encoded in the time domain through the application of the PGC technique. This approach allows a single receiver and acquisition system to be used in place of the three receivers 320, 322, 324 and acquisition system 326, 328, 330.

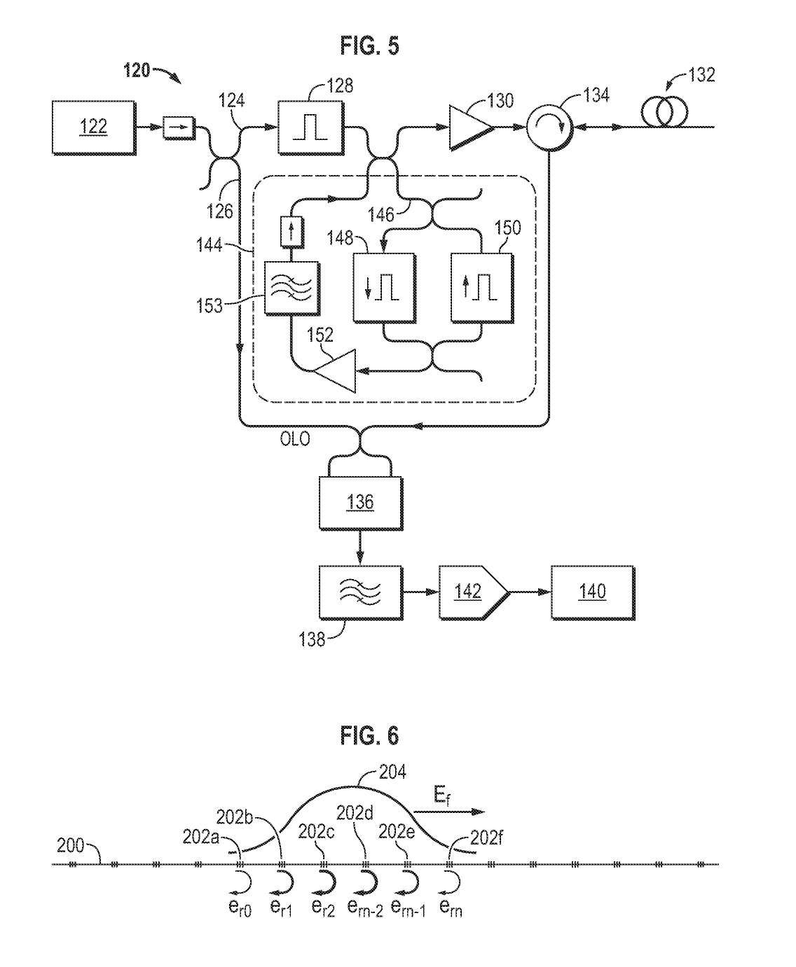

Still other approaches can be used to extract phase from the backscatter signal. For example, a variant of the basic hDVS arrangement is disclosed in U.S. Patent Publication No. 2013/0113629A1, and involves the use of multiple probe pulses that are launched quasi-simultaneously. The pulses interrogate the fiber independently, providing a number of benefits to the metrological performance of hDVS systems. One example of such a variant is shown schematically in FIG. 5 where a re-circulating frequency-translation circuit 144 can provide, from an individual probe pulse on path 146, a plurality of pulses, each having a slightly different frequency. A first pulse is provided by AOM 148 that introduces a slight downshift in the frequency of the pulse on path 146, and a second pulse is provided by AOM 150, that introduced a slight upshift in the frequency of the pulse on path 146. The first and second pulses are combined and amplified by EFDA 152 and filtered by filter 153. Other arrangements for achieving the same result also are disclosed in U.S. Patent Publication No. 2013/0113629A1.

### Use of Dense Arrays of Weak Reflectors in Distributed Sensors Based on Rayleigh Backscatter

In the previous examples illustrated in FIGS. 1-5, the sensing fibers 110, 132 and 310 can be a conventional optical fiber, unmodified from its manufacture. Embodiments disclosed herein improve the optical efficiency of a DVS measurement obtained by the examples of FIGS. 1-5 by replacing or modifying fibers 110, 132 and 310 so that the sensing fiber has discrete, spaced-apart weak reflectors along the length of the fiber (i.e., adding reflectors that are not naturally-occurring reflective features).

Coherent OTDR systems are frequently modeled by dividing the fiber into small intervals and notionally replacing the scattering from each interval by an equivalent reflection that has a random phase and amplitude. The embodiments described herein implement this notional process in the physical world by adding well-defined weak reflectors at intervals along the fiber. The location of and intervals between these reflectors need not be precise and could be random within defined ranges depending on the application in which the sensing fiber will be used.

FIG. 6 schematically illustrates a fiber 200 according to an embodiment. The fiber 200 includes multiple spaced-apart discrete reflectors 202a-f (here, in the form of gratings although other types of discrete reflectors can be used). A probe pulse 204 is shown propagating from left to right along the fiber 200, as indicated by energy field arrow labeled “E_{f}”. In this example, the probe 204 passes several reflectors 202a-f simultaneously so that each reflector 202a-f reflects a small amount of optical energy, resulting in reflected fields eᵣ₁₋₆ that are schematically represented with arrows shown arching back toward the launch end of the fiber 200. As shown in FIG. 6, the difference in thicknesses of the arched arrows corresponds to the relative strength of the reflected fields eᵣ₁₋ₙ. The reflected fields eᵣ₁₋ₙ from the reflectors 202a-f that are simultaneously illuminated by the probe 204 sum at the detector (e.g., receiver 112, receiver 136). The reflected fields eᵣ₁₋ₙ also can be summed with a local oscillator signal in the case where the measurement is made using the arrangement of FIG. 3 or with the backscatter from elsewhere in the fiber in the case of the arrangement of FIG. 2. In an arrangement that measures intensity of the detected fields, the detector just receives in turn the sum of the electric fields backscattered from each location that is acquired.

The fiber optic sensor array 200 illustrated in FIG. 6 results in a measurement process that is substantially different than what can be obtained using Rayleigh scattering from a conventional distributed fiber optic sensor. Specifically, the reflectors 202 in the fiber array 200 of FIG. 5 are localized rather than distributed, and the amplitude and phase of the reflectors 202 are a known or predictable function of probe frequency. Further, unlike a sensor with distributed reflectors, the amplitude of the reflection from each of the gratings 202 of the fiber array 200 can be tailored to match the particular requirements of the measurement. In effect, the arrangement of FIG. 5 can be viewed as building an artificial Rayleigh scattering process in the fiber by micro-structuring certain regions of it. This approach allows the signal to be increased without increasing the loss in proportion.

Moreover, the fact that the reflectors 202 are localized in the fiber array 200 results in their being individually less susceptible to external influences than a distributed reflector. This has certain benefits for the interpretation of the results in that the primary change that will occur when the strain or temperature of the fiber array 200 is varied is the optical path length between the reflectors 202, rather than the amplitude or phase of the reflectors themselves as would be the case with a reflector in a distributed sensor.

### Interrogation of the Densely Spaced Weak Reflector Fiber Array 200

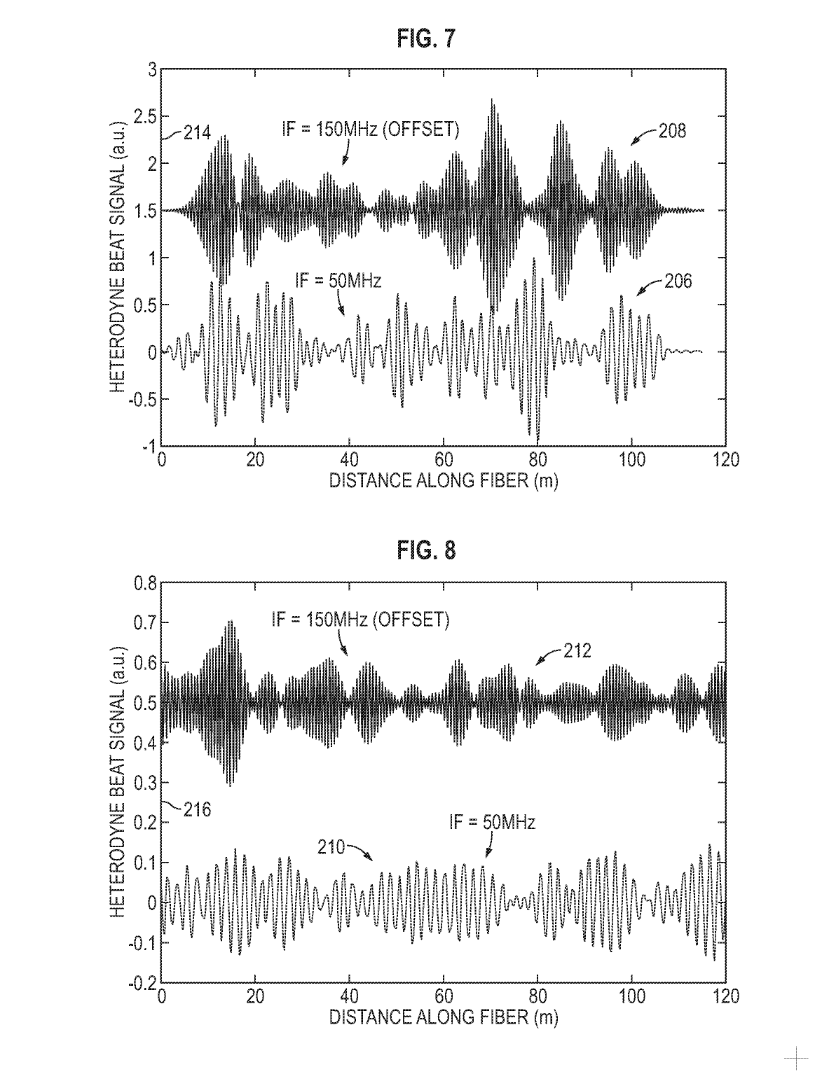

The fiber array 200 shown in FIG. 6 can be interrogated with the same arrangements that are used for Rayleigh backscatter, such as any of the arrangements shown in FIGS. 1-5 or referred to or described herein. As an example, FIG. 7 shows two signals 206, 208 acquired at different IF frequencies (i.e., 50 MHz and 150 MHz, respectively) using the technique illustrated in FIG. 5. These signals 206, 208 are indistinguishable in their appearance from conventional hDVS signals (e.g., signals 210, 212 shown in FIG. 8). However, in the example of FIG. 7, the probe power was reduced by a factor of 125 relative to a typical value (as represented in FIG. 8) and even then the signal collected by the acquisition system was about 4 times greater than that measured in a conventional fiber using Rayleigh scattering only. In the case of FIG. 7, the sensing fiber had an array 200 of weak reflectors 202 having a nominal 0.05% reflectivity at the probe wavelength. The spacing between reflectors 202 was 25 cm. The probe pulse duration was approximately 35 ns full width at half maximum. As such, about 16 gratings or reflectors 202 were illuminated with significant energy at the same time. For comparison, similar data is shown for a conventional fiber in FIG. 8, where the probe power was 125 times larger than the probe used to acquire the signals 206, 208 shown in FIG. 6). For comparison purposes, the signals 210, 212 shown in FIG. 8 are an extract of the signals obtained on a longer fiber plotted on a similar distance scale to the signal traces 206, 208 of FIG. 7.

FIGS. 7 and 8 demonstrate that interrogation of the fiber array 200 results in received signals (FIG. 7) that are increased in strength by a factor of 500 relative to the conventional fiber sensor arrangement that generated the signals in FIG. 8 (i.e., a combination of a factor of 125 for the reduction in probe power and a factor of 4 from the difference in scale on the ordinate axes 214, 216 of FIGS. 7 and 8). Although the units on the ordinates 214, 216 of FIGS. 7 and 8 are arbitrary, they are consistent between the two graphs.

In addition to strengthening the returned signal, the approach described herein allows tailoring of the returned signal. For example, by varying either the density and/or the strength of the gratings 202 of the array 200, the pseudo-backscatter can be varied along the fiber array 200. When the spacing between the gratings 202 is less than the duration of the probe 204, the signal level of the backscatter can be varied by changing either the reflectivity of the gratings 202 or the density of the gratings 202 (i.e. the separation between gratings 202). Collectively, these parameters affect the signal returning from the array 200 and are referred to as “array reflectivity” as distinct from the reflectivity of individual gratings 202.

Varying the array reflectivity can be useful for many different purposes. For example, the array reflectivity can be varied in order to concentrate measurements on a region of interest and ignore the portion of the fiber that makes up the downlead (or other portion of the fiber) connecting the interrogation system to the section of the fiber that is to be interrogated. Given that the signal returned from an array of gratings can be much stronger than the signal that is returned for a conventional backscatter system, varying the array reflectivity can allow the repetition frequency of the probe pulses to be increased. In a conventional backscatter system (for any measurand), the probe repetition frequency is limited by the constraint that there should be just one probe signal of a distinguishable type in the entire fiber length at any one time. (By distinguishable type, it is meant that multiple probe signals can co-exist in the fiber if the backscatter signal that they produce can be distinguished, for example because they are at a different frequency or they are encoded to make them distinguishable, for example using pulse-compression coding.) The reason for this limitation on repetition frequency is to avoid distance ambiguity that otherwise would occur when backscatter generated by several probe signals, sent at different times, arrive at the receiver from different parts of the fiber at the same time. Unless specific coding schemes are used, the origin of each backscatter signal cannot be discerned.

However, if the signal returned from the downlead section of the fiber is negligible compared with the signal returned from the section of the fiber in the region of interest, then it is possible to launch multiple probe signals that co-exist in the fiber. These probe signals travel in the fiber at intervals, but occupy some sections of the fiber at the same time as other probe signals occupy other sections of the fiber. By configuring the fiber to have a strong contrast in intensity between the signals returned from grating array region and the signals returned from the remainder of the fiber, the grating array region alone can be considered in selecting the probe repetition frequency. Consequently, the signal repetition frequency is limited by the round trip transit time in the grating array section of the fiber, and not by the entire fiber length as otherwise would be the case.

As a result, the probe repetition frequency can be increased substantially, which can improve the signal-to-noise ratio and dynamic range in certain types of sensing systems, notably distributed vibration sensing systems. As an example, assume that the entire length of the fiber comprising the downlead section together with the specific part of the fiber that is of interest is 10 km in length, but the sensing part is 1 km in length. In this example, with the conventional approach in an unmodified fiber, the maximum pulse repetition frequency (dictated by the round trip transit time to the far end and back) would be 10 kHz. In contrast, by varying the array reflectivity so that a 1 km section of the fiber provides a substantial signal, the repetition rate can be increased to 100 kHz. The higher repetition rate improves the signal-to-noise ratio, the maximum dynamic strain that can be measured and the frequency response of the sensing system.

In other applications, the array reflectivity can be varied so that the signal strength can be arranged to be stronger in some parts of the grating array than other parts of the grating array. As an example, the array reflectivity of the sensing fiber can be varied in order to equalize, at least approximately, the signal returning from the entire array. This can be accomplished, for example, by gradually increasing the strength of the more remote gratings to compensate for the accumulation of losses that will inevitably occur.

As another example, there may be some regions on the sensing fiber that are of less interest than other regions. In such regions, a lesser signal resolution may be acceptable and therefore the gratings in those regions can be less reflective. In fact, there may be some regions of the sensing fiber from which no signal is desired or that should be sampled sparsely. As an example, in some applications, the fiber sensor can be configured so that it includes precision sensors that are highly sensitive to the measurand of interest separated by regions that are less sensitive. Such a fiber optic sensing system is disclosed in WO2011/162868A2. However, if the regions where the sensing fiber is less sensitive are of interest, then the techniques disclosed herein can be employed so that the signals returned from the sensing fiber are predominantly from the less sensitive regions rather than from the highly sensitive, precision sensors. For instance, the reflectivity and/or density of gratings in the less sensitive regions of the sensing fiber can be arranged so that a stronger signal is returned from the less sensitive regions and weaker signals, or natural backscatter only, is returned from within the precision sensors. As another example, one might want to capture signals from just a small region of the precision sensor and therefore one might carefully profile the reflectivity/density combination of the gratings within the precision sensor.

It should be noted that the primary effect of increasing the array reflectivity according to the embodiments described herein is to increase the strength of the signal that is returned. It does not affect the sensitivity of the signal to a measurand, just the ability to measure the sensor's response to the measurand more precisely.

In yet other embodiments, because the gratings are wavelength selective, different parts of the sensing array can be configured to operate at different wavelengths. Wavelength selectivity allows considerable flexibility in the system design. As an example, this flexibility can be used simply to further increase the probe repetition rate by sending probe signals at different wavelengths that interrogate separately different parts of the fiber. For a particular probe wavelength, the array sections that are upstream (i.e. closer to the interrogation system) of the region designed for that wavelength will see low or no excess loss from the presence of the upstream gratings.

Returning to the parameters used in the example above, in the case of a 10 km fiber divided into 1 km regions, each fitted with weak reflectors at a different wavelength for each region, then the assembly can be interrogated at 100 kHz, rather than 10 kHz as would be the case with a conventional approach. Using wavelength-division multiplexing in this manner leads to changes to both the interrogation and acquisition systems. For example, the optical source can include a wavelength-adjustable laser to interrogate different sections of the fiber array in turn. Or, a parallel arrangement of multiple optical sources can be used. The system also can include wavelength combining and splitting components as well as receivers and acquisition channels for each wavelength used. Although the use of wavelength division multiplexing can increase the cost of interrogation and acquisition, it also results in improved sensing using fewer fibers. In many cases, such as in downhole sensing applications, the access to the sensors can dominate the cost of surface acquisition equipment.

In applications where the measurement time is of less concern (such as quasi-static measurands), then the costs associated with the interrogation system can be reduced by using a tunable (i.e., wavelength-adjustable) optical source as opposed to multiple independent sources. In such applications, measurements can be obtained from the sensing fiber array by selecting a region of the sensing fiber of a specific wavelength to be interrogated according to a predefined schedule, adjusting the laser output wavelength to match the particular region under consideration, acquiring the data and then moving to the next region of the sensing fiber that is on the schedule.

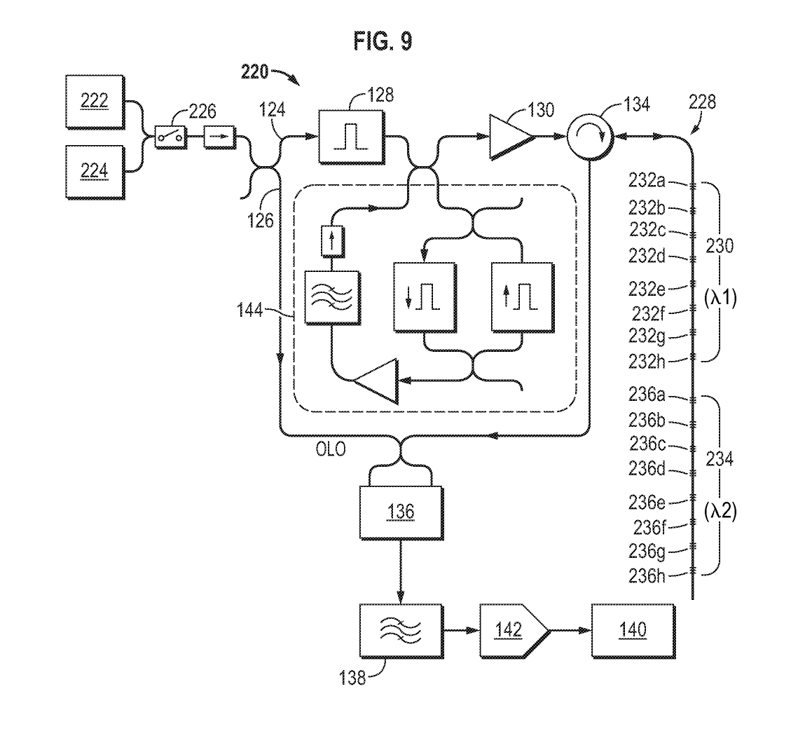

FIG. 9 schematically illustrates a wave-division multiplexing hDVS arrangement 220 that uses a single acquisition system having a set of continuous wave narrowband lasers 222, 224 that are switched in turn via an optical switch 226 to interrogate a sensing fiber array 228. The array 228 includes a first section 230 having gratings 232a-h that reflect light at a first wavelength λ₁ and a second section 234 having gratings 236a-h that reflect light at a second wavelength λ₂. In FIG. 9, two lasers 222, 224 are shown to generate outputs at wavelengths λ₁ and λ₂ that match the reflecting wavelengths of sections 230 and 234, respectively, of the array 228. It should be understood, however, that any number of optical sources could be employed depending on the particular application in which the sensing system is deployed.

As also described above with respect to FIG. 5, the outputs of lasers 222, 224 in FIG. 9 are split between a probe path 124 and a local oscillator path 126. On probe path 124, the outputs are modulated and frequency shifted by AOM 128. A portion of the output of AOM 128 is directed to the re-circulating frequency-translation circuit 144 that provides from an individual probe pulse on path 146, a plurality of pulses, each having a slightly different frequency. These pulses are combined with the pulse output from AOM 128 on the probe path 124, amplified by EDFA 130, and launched into the sensing fiber array 228 through the circulator 134. On path 126, the outputs of lasers 222, 224 are used to provide a local oscillator signal that is mixed with the backscatter returned from the array 228 at the balanced receiver 136. In other embodiments, a single wavelength-adjustable (or tunable) laser could be used in place of the multiple lasers 222, 224 and the optical switch 226. Note that in the hDVS arrangement 220 of FIG. 9, one set of receiver/acquisition equipment (i.e., balanced receiver 136, filter 138, acquisition system 142, and processing system 140) is used, and it is shared between the optical sources 222, 224 on a time-sliced basis.

In yet other examples, even dynamic measurements could be made using an arrangement that has a single acquisition path (such as the arrangement 220 of FIG. 9) and a single tunable optical source. In general, dynamic measurements call for rapid, successive acquisition of a sequence of data to determine patterns from a set of data, for example a mechanical vibration. However, even though the entire fiber is illuminated by the probe signal, sometimes limited regions of the fiber are of interest at any one time. As an example, one may be monitoring the noise caused by flow-through valves in an intelligent completion in a hydrocarbon well. Assuming a sensing fiber containing a sequence of densely-spaced gratings with different reflection wavelengths for each separate region of a well (e.g., the array 228 of FIG. 9, where the first section 230 is disposed along a first zone of the well and the second section 234 is disposed along a second zone of the well), one could select the wavelength corresponding to a particular valve prior to a planned change of the valve position.

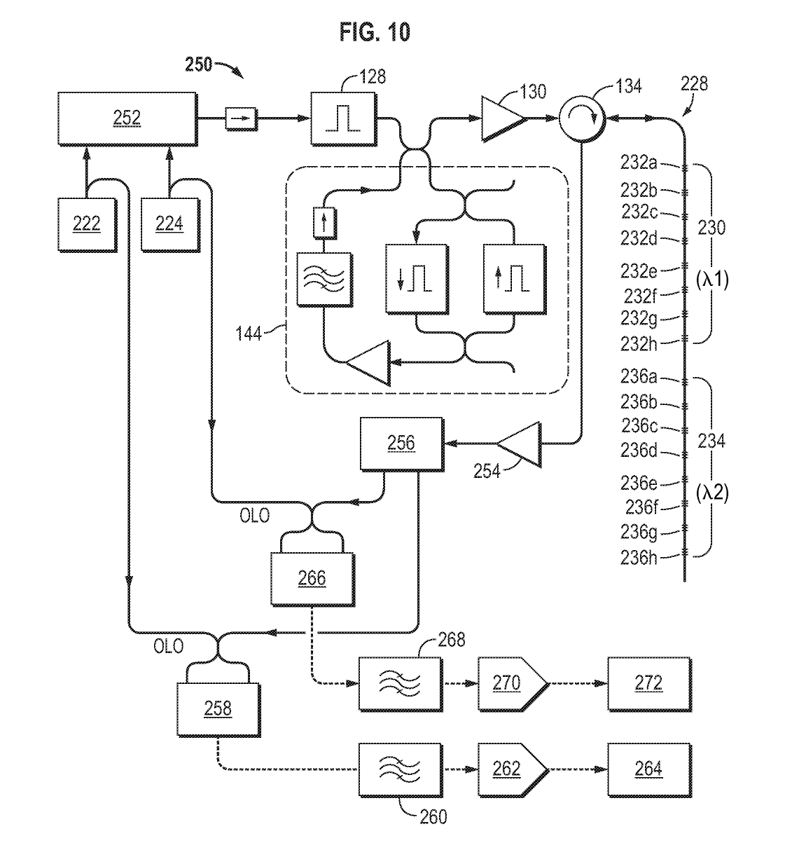

However, in some applications, it is desired to monitor the entire sensing fiber, in all its regions or zones, even if they are designed to respond to interrogation at different wavelengths. In this case, as shown schematically in the arrangement 250 of FIG. 10, the interrogating sources 222, 224 can be multiplexed using, for example an optical add/drop multiplexer (OADM) 252, into the pulse forming and amplification optical arrangement (i.e., AOM 128, frequency-translation circuit 144, and EDFA 130) and the backscatter returned from the fiber array 228 through the circulator 134 can be amplified by another EDFA 254 and then separated by another OADM 256. Each wavelength then can be directed to a separate coherent receiver and acquisition system. Although two interrogating sources, receivers and acquisition systems are shown in FIG. 10, it should be understood that any number of sources, receivers and acquisition can be used depending on the particular application in with the arrangement 250 is deployed.

As shown in FIG. 10, a first returned wavelength is directed to balanced receiver 258 where it is mixed with a local oscillator signal that is tapped from optical source 222. The intermediate frequency signal is filtered by bandpass filter 260 and then digitized and acquired by acquisition system 262 and processed by processing system 264. A second returned wavelength is directed to balanced receiver 266 where it is mixed with a local oscillator signal tapped from optical source 224 and the intermediate frequency signal is filtered by bandpass filter 268. The filtered IF signal is digitized and acquired by acquisition system 270 and processed by processing system 272.

The techniques and arrangements disclosed herein can also be used to provide redundancy to a sensing system. For example, it is often found that, in harsh environments, the transmission of the fiber degrades over time. If at the outset of use of the sensing system, the system is interrogated at wavelengths where the weak reflectors do not contribute to the backscatter signal, the interrogating source could be adjusted in wavelength after the fiber has degraded to provide a substantially stronger return signal and so provide resilience to the overall system.

The techniques and arrangements described herein can further be applied to each polarization state independently. This could be done using a polarization splitter and two separate acquisition channels, in the case of a strong birefringence, or a full Stokes analysis of all possible polarization states for more general cases. In other words, the use of densely-spaced, weak reflectors can also be applied to Polarization OTDR.

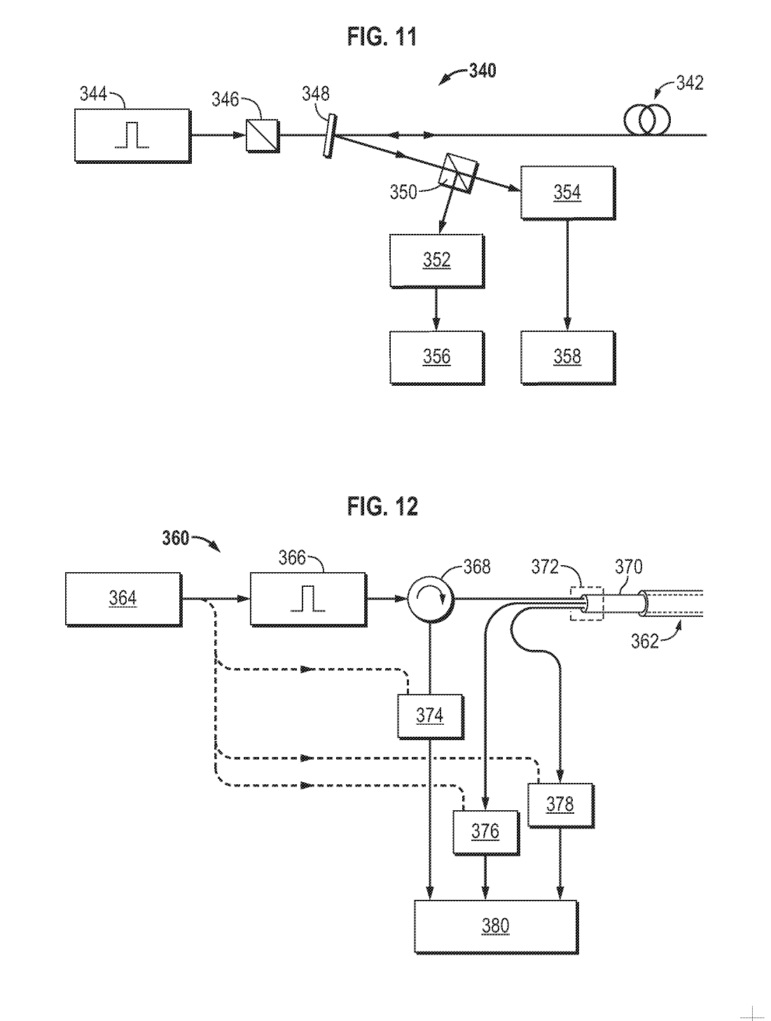

An embodiment of an example of a Polarization OTDR system 340 for interrogating and acquiring information from each polarization state of a polarization-maintaining (PM) sensing fiber 342 having densely spaced weak reflectors is shown schematically in FIG. 11. The system 340 includes an optical source 344 that generates probe pulses that are launched into the PM fiber 342 through a polarizer 346 and a beam splitter 348. Returned backscatter generated by the densely-spaced, weak reflectors in the fiber 342 in response to the probe pulses is polarized by polarizer 350 to separate the backscatter from each polarization state. Each polarization state is then received by respective receivers 352, 354 and the data is acquired by acquisition systems 356, 358 for subsequent analysis and processing.

Analyzing the polarization independently on the two principal states of a PM fiber has a number of uses. In fibers that preserve linear polarization (that have strong differences in propagation constants, known as birefringence, between two orthogonally disposed axes, x and y), further information can be gleaned. For example, it is often difficult to distinguish between changes in strain and changes in temperature. However because linear PM fibers also exhibit a sensitivity to strain and temperature of the birefringence, this characteristic can be used to overcome the ambiguity that a single measurement would leave.

In addition, certain fibers are designed to show a birefringence that varies with external pressure. Some of the designs have “side-holes” that transfer the pressure from an isostatic pressure unevenly to each of the linear birefringence. These types of fiber can be used for fully distributed (with a backscatter measurement) and quasi-distributed pressure measurements (well-separated reflector arrays).

The densely-spaced arrays of weak reflectors described herein could therefore be used in high-birefringence fibers to gain an additional measurand, such as separation of strain and temperature or a temperature-compensated pressure measurement.

The use of the two modes of a polarization-maintaining fiber to provide information allowing two measurands (e.g., temperature and strain or temperature and pressure) are one example of using the features of the embodiments described herein to gain more information from the sensing fiber. As another example, the use of densely spaced, weak reflectors can be used in fibers with few modes or fibers with multiple cores where additional information can be gained from the differential response to measurands from the different modes or the different cores.

FIG. 12 is a schematic representation of an example of an interrogation and acquisition system 360 that can be used with a multimode sensing fiber 362 (i.e., a fiber that can guide more than one transverse mode) having densely-spaced, weak reflectors. In the example shown, an optical source 364 (e.g., a narrowband laser) outputs an optical signal that is modulated by a pulse modulator 366 to generate one or more probe pulses that are launched into the multimode sensing fiber 362 through a circulator 368 and a multi-core fiber 370. The multi-core fiber 370 has three single-mode fiber cores that act as spatial filters that each capture a different speckle from the backscatter returned from the multimode fiber 362. Each captured speckle is directed through a fan-in device 372 to a respective acquisition system 374, 376, 378, where the speckles are detected and information from the speckles is acquired and processed. The outputs from the acquisition systems 374, 376, 378 then can be aggregated by aggregation system 380 to provide a measure of vibration experienced by the sensing fiber 362.

In some variants of system 360, the acquisition systems 374, 376, 378 can include a phase-comparison interferometer. In such variants, local oscillator signals are tapped off from the optical source 364 (as represented by the dashed lines) for mixing with the returned speckles at the receiver. It should further be understood that other variants for interrogating the multimode fiber 362 are contemplated that can be used in conjunction with the mode filtering arrangement shown in FIG. 12, including any of the techniques illustrated in FIGS. 1-5.

Although the arrays of weak gratings as discussed above are intended as reflectors, they can also be used to determine measurands that will modulate the center wavelength, such as local temperature or strain. This part of the information conveyed by the gratings can be interrogated as described, for example, in Cooper, D. J. F., et al., Time-division multiplexing of large serial fiber-optic Bragg grating sensor arrays, APPLIED OPTICS, 2001, pp. 2643-54, in addition to the interferometric interrogation techniques disclosed herein.

In some embodiments, the systems and techniques described herein may be employed in conjunction with an intelligent completion system disposed within a well that penetrates a hydrocarbon-bearing earth formation. Portions of the intelligent completion system can be disposed within cased portions of the well, while other portions of the system can be in the uncased, or open hole, portion of the well. The intelligent completion system can comprise one or more of various components or subsystems, which include without limitation: casing, tubing, control lines (electric, fiber optic, or hydraulic), packers (mechanical, sell or chemical), flow control valves, sensors, in flow control devices, hole liners, safety valves, plugs or inline valves, inductive couplers, electric wet connects, hydraulic wet connects, wireless telemetry hubs and modules, and downhole power generating systems. Portions of the systems that are disposed within the well can communicate with systems or sub-systems that are located at the surface. The surface systems or sub-systems in turn may communicate with other surface systems, such as systems that are at locations remote from the well.

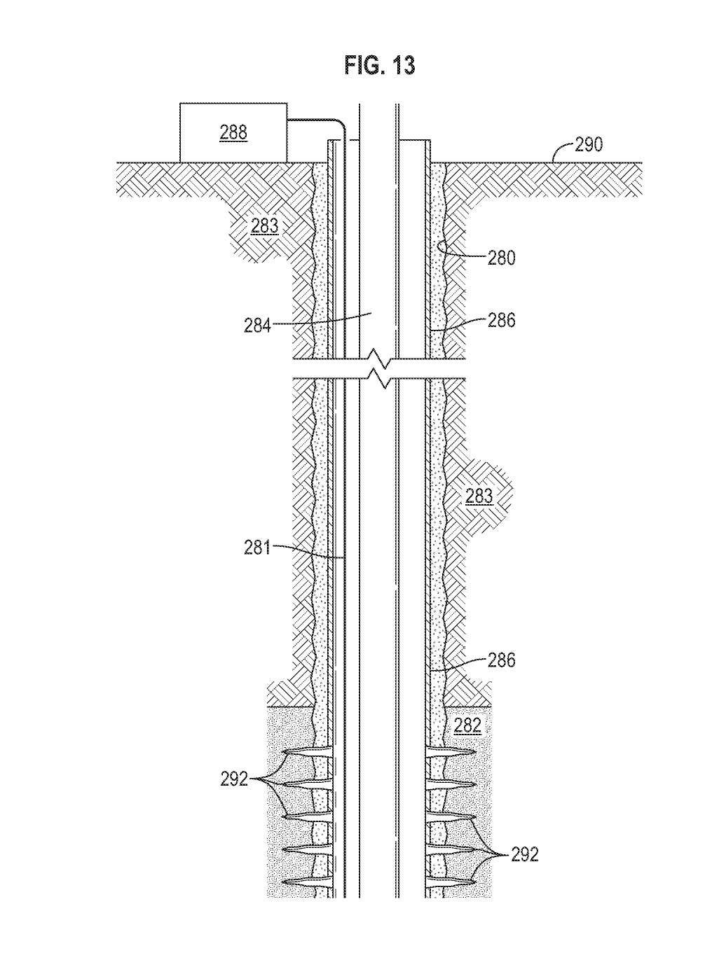

For example, as shown in FIG. 13, a fiber optic cable 281 that includes an array of densely spaced, weak reflectors (such as any of the sensing fibers 200, 228, 342, 362) is deployed in a wellbore 280 to observe physical parameters associated with a region of interest 282. In some embodiments, the fiber optic cable 281 can be deployed through a control line and can be positioned in the annulus between a production tubing 284 and a casing 286 as shown. In some embodiments, the fiber optic cable 281 would have been deployed previously for example during completion of the well, the fiber optic cable is positioned between the casing 286 and a subterranean formation 283. In some embodiments, the fiber optic cable 281 is deployed through a wireline cable, a slickline cable or any other type of cables that may be used for well interventions, this embodiment may be useful for deployment for purpose of seismic survey as it will be explained further. An observation system 288, which includes any of the interrogation, detection, acquisition and processing systems described herein (e.g., the systems shown in FIGS. 1-5 and FIGS. 9-12 and the accompanying description), can be located at a surface 290 and coupled to the fiber optic cable 281 to transmit the probe pulses, detect returned backscatter signals, and acquire information to determine the parameters of interest (e.g., temperature, strain, pressure) in the manners described above.

In the embodiment shown in FIG. 13, to reach the region of interest 282 in the subterranean formation 283, the wellbore 290 is drilled through the surface 290 so that it penetrates the subterranean formation 283, and the casing 286 is lowered into the wellbore 280. Perforations 292 are created through the casing 286 to establish fluid communication between the wellbore 280 and the formation in the region of interest 282. The production tubing 284 is then installed and set into place such that production of fluids through the tubing 284 can be established. Although a cased well structure is shown, it should be understood that embodiments of the invention are not limited to this illustrative example. Uncased, open hole, gravel packed, deviated, horizontal, multi-lateral, deep sea or terrestrial surface injection and/or production wells (among others) may incorporate the systems as described. The fiber optic cable can be permanently installed in the well or can be removably deployed in the well, such as for use during remedial operations.

In many applications, strain and/or temperature measurements obtained from the region of interest can provide useful information that may be used to increase productivity. For instance, the measurements may provide an indication of the characteristics of a production fluid, such as flow velocity and fluid composition. This information then can be used to implement various types of actions, such as preventing production from water-producing zones, slowing the flow rate to prevent coning, and controlling the injection profile, so that more oil is produced as opposed to water.

The embodiments described herein also can be used in conjunction within fiber optic seismic sensing systems used to survey a geologic formation. For example, in the arrangement shown in FIG. 13, the fiber optic sensor cable 281 can detect seismic signals that originate outside the borehole 280, such as from a seismic surveying source located at the surface 290 or within another borehole or from a seismic event occurring within the geologic formation. In the case of a seismic survey, as the seismic signals propagate through the subterranean formation 283, they reflect and refract from various geologic features and these various reflections and refractions of the seismic signal impinge upon the fiber optic sensor cable 281, inducing a dynamic strain. Measurement of the dynamic strain can thus provide information about the geological characteristics of the subterranean formation 283. When the cable 281 includes a fiber optic sensor having densely spaced, weak reflectors (such as sensor 200) and is interrogated as described herein, the detection of the seismic signals can be enhanced. In a variant of a seismic surveying system, the fiber optic cable 281 can be located above the subterranean formation, such as at the earth surface or, in the case of marine surveying, in a streamer towed by a ship.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the invention.

What is claimed is:

1. A fiber optic sensing system to monitor a parameter of interest, comprising:
an optical fiber sensor having a plurality of non-naturally occurring discrete reflectors disposed along a length of an optical fiber at spaced-apart locations, each of the discrete reflectors having a reflectivity of less than 1% at a first wavelength;
an interrogation system to launch probe signals at the first wavelength into the optical fiber sensor to monitor the parameter of interest; and
a receiver to receive backscattered light reflected from the discrete reflectors in response to the probe signals,
wherein the spacing between adjacent reflectors is less than the spatial resolution of the interrogation system so that the backscattered light reflected from at least two discrete reflectors overlaps at the receiver.

2. The system as recited in claim 1, wherein the probe signals are probe pulses having a spatial pulse width, and wherein an average length of the spacing between adjacent discrete reflectors is less than the spatial pulse width of the probe pulses launched into the optical fiber sensor.

3. The system as recited in claim 1, wherein the electric fields of the backscattered light received from the at least two discrete reflectors are combined at the receiver.

4. The system as recited in claim 1, wherein the reflectors have a reflectivity of less than 0.1% at the first wavelength.

5. The system as recited in claim 1, wherein the reflectors are Bragg gratings inscribed in the optical fiber.

6. The system as recited in claim 1, wherein the spacing between adjacent discrete reflectors is varied along the length of the optical fiber.

7. The system as recited in claim 1, wherein the reflectivities of the discrete reflectors are varied along the length of the optical fiber.

8. The system as recited in claim 7, wherein the reflectivities of the discrete reflectors increase along the length of the optical fiber.

9. The system as recited in claim 1, wherein the optical fiber includes a first section along which the non-naturally occurring discrete reflectors have a reflectivity of less than 1% at the first wavelength, and a second section along which the non-naturally occurring discrete reflectors having a reflectivity of less than 1% at a second wavelength, wherein the interrogation system launches probe signals at the first wavelength to monitor the parameter of interest in the first section, and further wherein the interrogation system launches probe signals at the second wavelength to monitor the parameter of interest in the second section.

10. The system as recited in claim 1, wherein the parameter of interest is a dynamic strain incident on the optical fiber.

11. The system as recited in claim 1, wherein the optical fiber is a polarization-maintaining fiber having a plurality of polarization states, and wherein the interrogation system launches probe signals to interrogate each polarization state separately.

12. The system as recited in claim 1, wherein the optical fiber has multiple cores, and wherein the interrogation system launches probe signals to interrogate each core separately.

13. The system as recited in claim 1, wherein the optical fiber has multiple transverse modes, and wherein the backscattered light is spatially filtered to obtain information from each mode separately.

14. A method to monitor a parameter in a region of interest, comprising:
deploying an optical fiber sensor in the region of interest, the optical fiber sensor having a plurality of non-naturally occurring, spaced-apart reflectors, each reflector having a reflectivity at a first wavelength that is less than 1%;
launching probe signals into the optical fiber sensor to monitor the parameter in the region of interest;
receiving backscattered light generated by the reflectors at the first wavelength in response to illumination by the probe signals; and
determining the parameter based on the received backscattered light,
wherein the spacing between at least two reflectors is such that the received backscattered light is a combination of the backscattered light generated by the at least two reflectors when simultaneously illuminated by one of the probe signals.

15. The method as recited in claim 14, wherein the probe signals comprise a plurality of optical pulses having a spatial pulse width, and wherein an average spacing between adjacent reflectors is less than the spatial pulse width of the optical pulses launched into the optical fiber sensor.

16. The method as recited in claim 14, wherein the reflectors have a reflectivity of less than 0.1% at the first wavelength.

17. The method as recited in claim 14, wherein a density of the reflectors is varied along the length of the optical fiber.

18. The method as recited in claim 14, wherein the reflectivity of the reflectors at the first wavelength is varied along the length of the optical fiber.

19. The method as recited in claim 14, wherein the optical fiber includes a first section along which the reflectors have a reflectivity of less than 1% at the first wavelength, and a second section along which the reflectors have a reflectivity of less than 1% at a second wavelength, and the method further comprises launching probe signals at the first wavelength to monitor the parameter along the first section, and launching probe signals at the second wavelength to monitor the parameter along the second section.

20. The method as recited in claim 14, wherein the reflectors are Bragg gratings inscribed in the optical fiber.

21. The method as recited in claim 20, wherein the Bragg gratings are inscribed in a first section of the optical fiber and not in a second section of the optical fiber, and wherein the method further comprises launching the probe signals at a repetition frequency that is determined based on the round trip transit time of light in the first section of the fiber.

22. The method as recited in claim 14, wherein the optical fiber is a polarization-maintaining fiber having a plurality of polarization states, and wherein launching comprises separately launching probe signals into the optical fiber sensor to monitor the parameter in the region of interest for each polarization state, and wherein determining the parameter is based on the backscattered light received for each of the polarization states.

23. The method as recited in claim 14, wherein the region of interest is a hydrocarbon-producing well, and the parameter is a dynamic strain experienced by the optical fiber sensor.

24. The method as recited in claim 14, wherein the region of interest is a borehole penetrating a subterranean formation, and the parameter is a dynamic strain experienced by the optical fiber sensor due to seismic signals propagating through the subterranean formation.

25. The method as recited in claim 14, wherein the region of interest in which the optical fiber sensor is deployed is above a subterranean formation, and the parameter is a dynamic strain experienced by the optical fiber sensor due to a seismic signal propagating within the subterranean formation.

26. A method to monitor a parameter in a region of interest, comprising:
deploying an optical fiber sensor with a wireline cable in the region of interest, the optical fiber sensor having a plurality of non-naturally occurring, spaced-apart reflectors, each reflector having a reflectivity at a first wavelength that is less than 1%;
launching probe signals into the optical fiber sensor to monitor the parameter in the region of interest;
receiving backscattered light generated by the reflectors at the first wavelength in response to illumination by the probe signals; and
determining the parameter based on the received backscattered light,
wherein the spacing between at least two reflectors is such that the received backscattered light is a combination of the backscattered light generated by the at least two reflectors when simultaneously illuminated by one of the probe signals.

27. A fiber optic monitoring system for measuring a parameter associated with a subterranean formation, comprising:
an optical fiber deployed in a wellbore that penetrates a subterranean formation, the optical fiber having a plurality of non-naturally occurring reflectors disposed at spaced-apart locations along a first section of the optical fiber;
an optical source to launch probe signals having components at a first wavelength into the optical fiber, wherein the reflectors have a reflectivity at the first wavelength of less than 1%;
a receiver to detect returned scattered light reflected by the reflectors in response to the launched probe signals, wherein the scattered light returned from at least two adjacent reflectors overlaps at the receiver; and
an acquisition and processing system to determine at least one parameter of interest experienced by the optical fiber along the first section based on the detected returned scattered light.

28. The system as recited in claim 27, wherein the probe signals comprise optical pulses that are launched into the optical fiber at a repetition frequency that is determined based on a round trip transit time of an optical pulse in the first section of the optical fiber.

29. The system as recited in claim 27, wherein the optical fiber further comprises a second section having a plurality of reflectors, wherein the reflectors in the second section having a reflectivity of less than 1% at a second wavelength, and wherein the optical source launches probe signals having components at the second wavelength to measure the parameter of interest experienced by the optical fiber along the second section.

30. The system as recited in claim 27, wherein the spacing between the reflectors varies along the length of the first section of the optical fiber.

31. The system as recited in claim 27, wherein the reflectivity at the first wavelength of the reflectors in the first section varies along the length of the first section.

32. The system as recited in claim 27, wherein the reflectors are Bragg gratings inscribed in the first section of the optical fiber.

33. The system as recited in claim 27, wherein the subterranean formation comprises a hydrocarbon-bearing reservoir, and wherein the parameter of interest is indicative of a flow of a hydrocarbon fluid produced from the reservoir.

34. The system as recited in claim 33, wherein the parameter of interest is a dynamic strain experienced by the optical fiber.

35. The system as recited in claim 33, wherein the dynamic strain is induced by a seismic signal incident on the optical fiber.
